(19) United States
(12) Patent Application Publication
(10) Pub. No.: US 2025/0223003 A1
(43) Pub. Date: Jul. 10, 2025

(54) BICYCLE FRONT-END MECHANISM FOR QUICK ASSEMBLY

(71) Applicant: TIANJIN XUFENG SPORTS EQUIPMENT MANUFACTURE CO., LTD., TIANJIN (CN)

(72) Inventor: YU-CHI CHEN, TIANJIN (CN)

(21) Appl. No.: 18/406,533

(22) Filed: Jan. 8, 2024

(51) Int. Cl. B62K 21/24; B62K 3/02; B62K 21/02

(52) U.S. Cl. CPC B62K 21/24; B62K 3/02; B62K 21/02

(57) ABSTRACT

A bicycle front-end mechanism for quick assembly includes a fork set, a stem set, and a fork bowl set. The stem set is removably mounted around the fork set and includes a stem, a positioning member, a positioning plate, and a connection member. The stem has a first combination bore mounted around the fork set and a second combination bore connected with a handle bar. The positioning member and the positioning plate are coaxially disposed in the first combination bore along the center of the first combination bore by the connection member. A connection tube part has one end engaged with the positioning member. The fork bowl set is removably mounted around the fork set. The engagement of the positioning member and the fork set achieves the efficient assembly of the stem set, the fork bowl set, and the fork set while a guidance effect is provided.

### BACKGROUND OF THE INVENTION

### 1. Field of the Invention

The present invention relates to bicycle related fields, and more particularly, to a bicycle front-end mechanism for quick assembly.

### 2. Description of the Related Art

The assembly of a bicycle is a relatively complicated procedure and requires a variety of professional tools. For non-professionals or unskilled people, such task is a time-consuming and laborious procedure. Also, the assembly process of a traditional bicycle requires different specialized tools, and several complicated adjustment steps have to be carried out for a proper assembly of the bicycle.

During the assembly procedure of a conventional bicycle, when assembling components with guiding functions such as the stem set, fork bowl set, and the fork set of the front-end mechanism of the bicycle, professional tools are required, and the calibration and adjustment operations have to be carried out after the completion of the assembly procedure. If the front-end mechanism of the bicycle is not properly adjusted, its function is possibly prevented from working properly, thereby causing potential danger to the bicycle rider. Also, if the front-end components of the bicycle are not installed properly, the cooperation between the components will be hindered to cause excessive wearing or failure.

### SUMMARY OF THE INVENTION

To improve the issues above, the present invention discloses a bicycle front-end mechanism for quick assembly. By structurally simplifying the stem set, the fork bowl set, and the fork set and engaging the positioning member and the fork set, the stem set, the fork bowl set, and the fork set are effectively assembled and provided with a proper guidance effect.

For achieving the aforementioned objectives, an embodiment of the present invention provides a bicycle front-end mechanism for quick assembly, comprising:
a fork set comprising a tube member, the tube member having a connection tube part and a fork part, the fork part being connected with a wheel;
a stem set removably mounted around the tube member of the fork set, the stem set having a stem, a connection member, a positioning member, and a positioning plate, the stem having a first combination bore and a second combination bore, the first combination bore mounted around the connection tube part of the tube member, the positioning member and the positioning plate being disposed in the first combination bore in an coaxial arrangement along a center of the first combination bore by the connection member, the connection tube part having one end engaged with the positioning member, the second combination bore connected with a handle bar; and
a fork bowl set removably mounted around the tube member of the fork set, the fork bowl set having a head tube, an upper bowl, and a lower bowl, the head tube mounted around the connection tube part of the tube member, the upper bowl and the lower bowl disposed on two ends of the head tube, respectively, the upper bowl disposed between the head tube and the stem.

In another embodiment of the present invention, the fork set further comprises a star nut engaged in one end of the connection tube part, such that the connection member of the stem set is connected with the star nut.

In another embodiment of the present invention, the connection tube part comprises a first end and an opposite second end, wherein the star nut is engaged in the connection tube part at the first end, and the first end is engaged with the positioning member.

In another embodiment of the present invention, the fork set further comprises a block ring mounted around the outer periphery of the connection tube part in adjacent to the second end, and the lower bowl is connected with the block ring.

In another embodiment of the present invention, the stem set further comprises a cap coaxially connected with the positioning member along the center of the first combination bore through the connection member, and the positioning member is disposed between the cap and the positioning plate.

In another embodiment of the present invention, the first end of the connection tube part comprises a concave groove, and one side of the positioning member comprises a protrusion part, so that the groove and the protrusion part are engaged.

In another embodiment of the present invention, the outer periphery of the positioning plate comprises a concave positioning limiting groove. When the positioning member is connected with the positioning plate, the protrusion part of the positioning member is located in the positioning limiting groove.

In another embodiment of the present invention, the positioning member comprises a connection part. The connection part comprises a first face and an opposite second face. The connection part has an opening passing therethrough, and the cap is connected with the first face and partially engaged in the opening. The second face integrally forms the protrusion part, so that the connection member is connected with the positioning plate through the opening.

In another embodiment of the present invention, the cap comprises an outer lateral face and an opposite inner lateral face. The inner lateral face faces the first combination bore. The outer lateral face comprises a concave recess, and one end of the connection member is located in the recess. The inner lateral face comprises a protruding combination part, which has a trapezoid-shaped sectional face. The combination part is engaged in the opening.

In another embodiment of the present invention, the fork bowl set further comprises a washer mounted around the outer periphery of the connection tube part and disposed between the upper bowl and the first combination bore of the stem.

With such configuration, the present invention structurally simplifies the stem set, the fork bowl set, and the fork set. When the stem set and the fork bowl set are mounted around the fork set, the positioning member and the fork set are engaged, so as to complete the assembly of the stem set, the fork bowl set, and the fork set and achieve a guidance effect. Therefore, the present invention improves the complexity during the assembly of the front-end mechanism of the conventional bicycle which requires specialized tools, and also improves the issue of calibration and adjustment requirement.

Also, when the positioning plate is connected with the positioning member, the position limiting groove of the positioning plate ensures the unidirectional connection with the positioning member, so as to provide an error proof effect preventing the erroneous installation thereby ensuring the positional correctness of the connection between each element.

Also, when the cap is connected with the positioning member, the combination part having the trapezoid-shaped sectional face is efficiently engaged with the positioning member, and the guidance effect is provided to ensure that the positioning member and the center of the cap are arranged in a coaxially alignment. Therefore, the present invention achieves an efficient assembly and a guidance effect.

### BRIEF DESCRIPTION OF THE DRAWINGS

FIG. 1 is a perspective view of the present invention.

FIG. 2 is an exploded view of the present invention.

FIG. 3 is an exploded view of the fork set in accordance with the present invention.

FIG. 4 is an exploded view of the stem set in accordance with the present invention.

FIG. 5 is an exploded view of the fork bowl set.

FIG. 6 is a cross-sectional view taken along line A-A in FIG. 1.

FIG. 7 is a partially enlarged view of FIG. 6.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

The directional terms of, for example, “up”, “down”, “front”, “rear”, “left”, “right”, “inner”, “outer”, and “side” are only used herein for illustrating the relative directions shown in the drawings. Therefore, the directional terms are applied for the purpose of illustration and understanding of the present invention, instead of limiting the present invention.

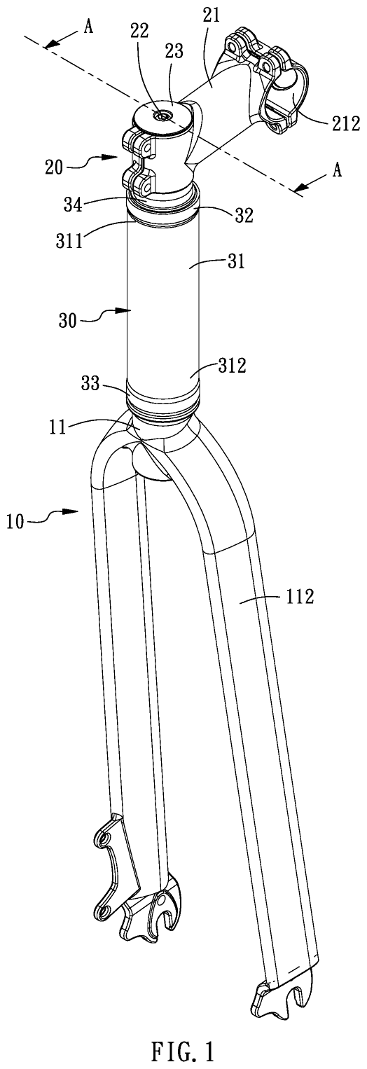

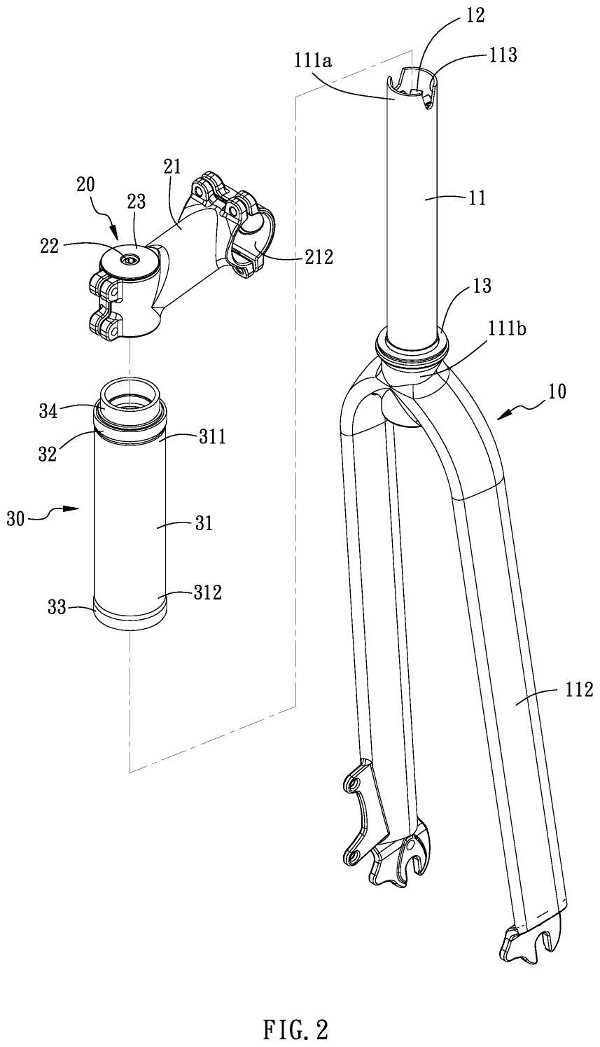

Referring to FIG. 1 to FIG. 7, the present invention provides a bicycle front-end mechanism for quick assembly, comprising a fork set 10, a stem set 20, and a fork bowl set 30.

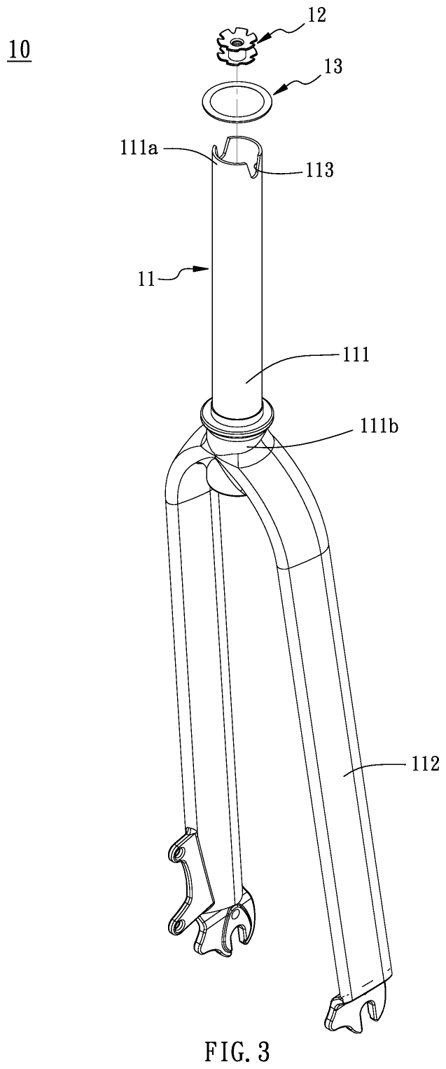

The fork set 10 comprises a tube member 11, a star nut 12, and a block ring 13. The tube member 11 comprises a connection tube part 111 and a fork part 112. The connection tube part 111 is formed in a column tube and comprises a first end 111a and an opposite second end 111b, as shown by FIG. 1 and FIG. 3. Therein, the fork part 112 integrally extends outward from the second end 111b of the connection tube part 111. The fork part 112 is allowed to be connected with a wheel (not shown).

Also, the star nut 12 is engaged in the first end 111a of the connection tube part 111. The block ring 13 is mounted around the outer periphery of the connection tube part 111 in adjacent to the second end 111b. Therein, the first end 111a of the connection tube part 111 comprises a concave groove 113, which is allowed to be formed in a rectangular, triangular, or arc shape. In the embodiment, two grooves 113 are included and disposed in symmetrical arrangement, and the two grooves 113 are formed in an arc shape, as shown by FIG. 3.

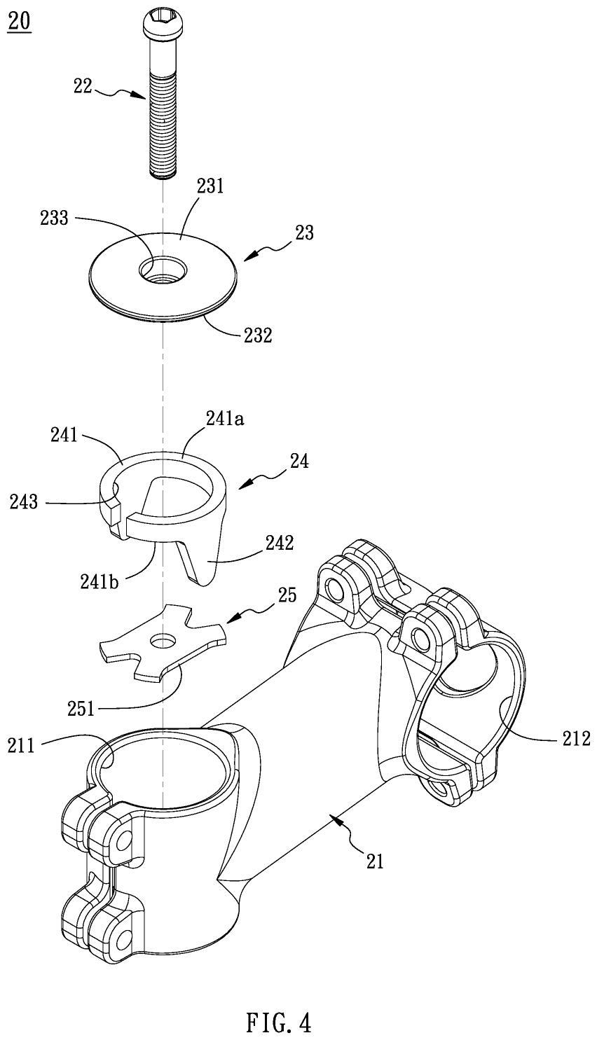

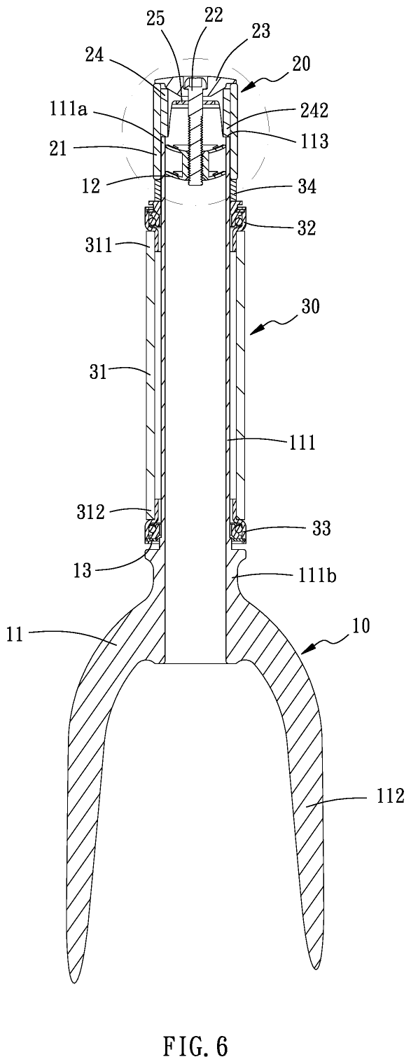

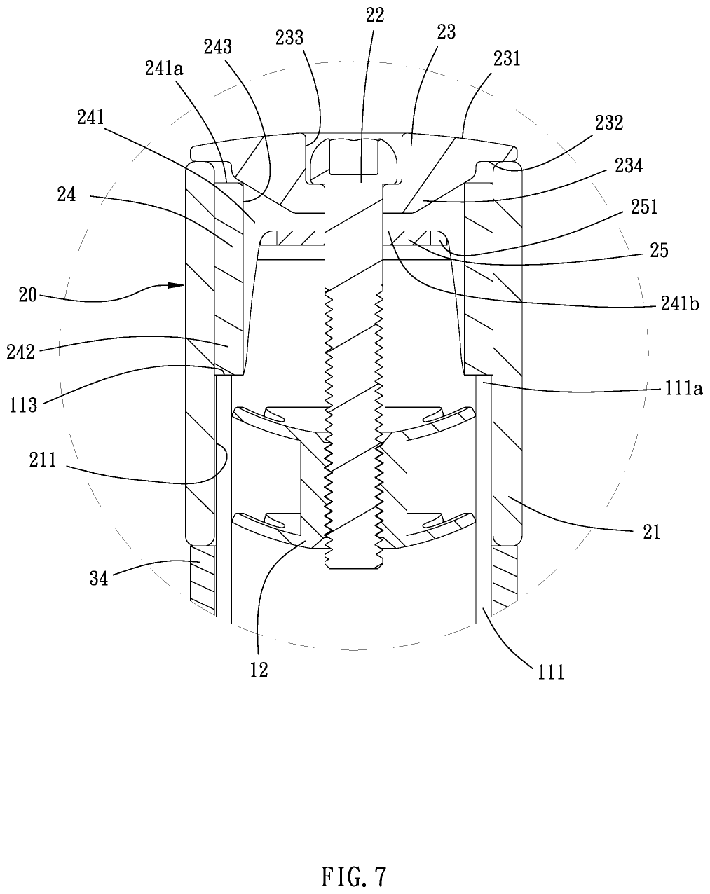

The stem set 20 is removably mounted around the tube member 11 of the fork set 10. The stem set 20 comprises a stem 21, a connection member 22, a cap 23, a positioning member 24, and a positioning plate 25. The stem 21 comprises a first combination bore 211 and a second combination bore 212. The first combination bore 211 of the stem 21 is mounted around the connection tube part 111 of the tube member 11. Therein, the cap 23, the positioning member 24, and the positioning plate 25 are disposed in the first combination bore 211 in an coaxial arrangement along a center of the first combination bore 211 by the connection member 22. The cap 23 is able to be connected with the positioning member 24, and the positioning member 24 is disposed between the cap 23 and the positioning plate 25. Therein, one end of the connection member 22 is able to be connected with the star nut 12, and the positioning member 24 is able to be engaged with the first end 111a of the connection tube part 111 of the tube member 11, as shown by FIG. 4, FIG. 6, and FIG. 7. The second combination bore 212 is allowed to be connected with a handle bar (not shown). In the embodiment, the connection member 22 is a screw member.

Also, the cap 23 comprises an outer lateral face 231 and an opposite inner lateral face 232. The inner lateral face 232 faces the first combination bore 211. The outer lateral face 231 comprises a concave recess 233, and one end of the connection member 22 is located in the recess 233. Therein, the inner lateral face 232 comprises a protruding combination part 234. The combination part 234 has a tapering outer periphery and a trapezoid shape sectional face, as shown by FIG. 6 and FIG. 7.

Further, the positioning member 24 comprises a connection part 241 and a protrusion part 242. The connection part 241 comprises a first face 241a and an opposite second face 241b. The connection part 241 comprises an opening 243 passing therethrough. The combination part 234 of the cap 23 is able to be connected with the first face 241a of the connection part 241 and partially engaged in the opening 243. The second face 241b of the connection part 241 integrally forms the protrusion part 242. The connection member 22 is connected with the positioning plate 25 through the opening 243. Therein, the protrusion part 242 of the positioning member 24 is allowed to be engaged with the recess 113 of the first end 111a of the tube part 111 in a concave-convex manner, as shown by FIG. 6 and FIG. 7. In the embodiment, two protrusion parts 242 are included and disposed in a symmetrical arrangement, and the protrusion parts 242 are formed in an arc shape, as shown by FIG. 4.

Also, the largest outer diameter of the positioning plate 25 matches the largest outer diameter of the connection part 241 of the positioning member 24. Therein, the outer periphery of the positioning plate 25 comprises a concave position limiting groove 251. When the positioning member 24 is connected with the positioning plate 25, the protrusion part 242 of the positioning member 24 is located in the position limiting groove 251. In the embodiment, two position limiting grooves 251 are included and disposed in a symmetrical arrangement, as shown by FIG. 4.

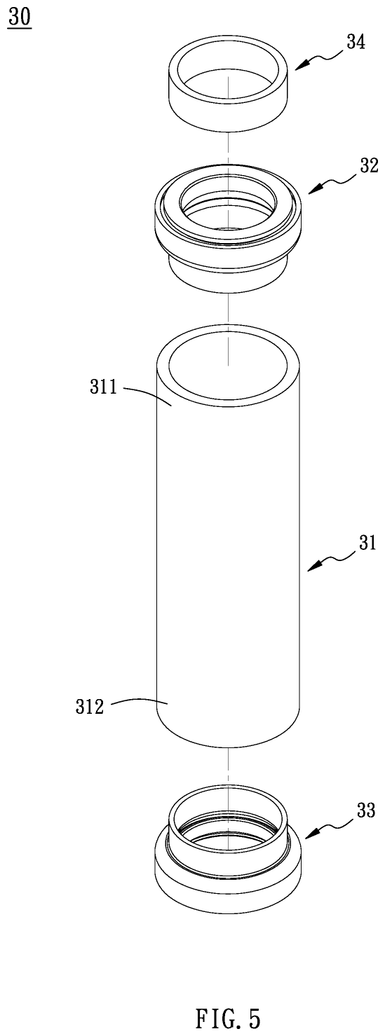

The fork bowl set 30 is removably mounted around the tube member 11 of the fork set 10. The fork bowl set 30 comprises a head tube 31, an upper bowl 32, a lower bowl 33, and a washer 34. The head tube 31 is mounted around the connection tube part 111 of the tube member 11. Therein, the head tube 31 comprises a first connection end 311 and an opposite second connection end 312. The upper bowl 32 and the lower bowl 33 are disposed on the first connection end 311 and the second connection end 312 of the head tube 31, respectively. The washer 34 is mounted around the outer periphery of the connection tube part 111 of the tube member 11. Therein, the upper bowl 32 is disposed between the head tube 31 and the stem 21, the washer 34 is mounted between the upper bowl 32 and the first combination bore 211 of the stem 21, and the lower bowl 33 is connected with the block ring 13, as shown by FIG. 5 and FIG. 6.

With the foregoing configuration, advantages of the present invention will be illustrated below.

The present invention structurally simplifies the stem set 20, the fork bowl set 30, and the fork set 10. When the stem set 20 and the fork bowl set 30 are mounted around the fork set 10, the positioning member 24 is engaged with the fork set 10, such that the stem set 20, the fork bowl set 30, and the fork set 10 are assembled, and a guidance effect is provided.

Also, when the positioning plate 25 is connected with the positioning member 24, the position limiting groove 251 of the positioning plate 25 is unidirectionally connected with the positioning member 24, so as to achieve an error proof effect and prevent the erroneous installation direction, thereby ensuring the connection correctness of each element.

Further, when the cap 23 is connected with the positioning member 24, the combination part 234 having a trapezoid-shaped sectional face is efficiently engaged with the positioning member 24, and a guidance effect is provided, thereby ensuring that the positioning member 24 and the center of the cap 23 are arranged on an identical axis. Therefore, the present invention achieves an efficient assembly and provides the guidance effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bicycle front-end mechanism for quick assembly, comprising:
a fork set comprising a tube member, the tube member having a connection tube part and a fork part, the fork part being connected with a wheel;
a stem set removably mounted around the tube member of the fork set, the stem set having a stem, a connection member, a positioning member, and a positioning plate, the stem having a first combination bore and a second combination bore, the first combination bore mounted around the connection tube part of the tube member, the positioning member and the positioning plate being disposed in the first combination bore in an coaxial arrangement along a center of the first combination bore by the connection member, the connection tube part having one end engaged with the positioning member, the second combination bore connected with a handle bar; and
a fork bowl set removably mounted around the tube member of the fork set, the fork bowl set having a head tube, an upper bowl, and a lower bowl, the head tube mounted around the connection tube part of the tube member, the upper bowl and the lower bowl disposed on two ends of the head tube, respectively, the upper bowl disposed between the head tube and the stem.

2. The bicycle front-end mechanism of claim 1, wherein the fork set further comprises a star nut engaged in one end of the connection tube part, and the connection member of the stem set is connected with the star nut.

3. The bicycle front-end mechanism of claim 2, wherein the connection tube part comprises a first end and an opposite second end; the star nut is engaged in the connection tube part at the first end, and the first end is engaged with the positioning member.

4. The bicycle front-end mechanism of claim 3, wherein the fork set comprises a block ring mounted around an outer periphery of the connection tube part and arranged in adjacent to the second end; the lower bowl is connected with the block ring.

5. The bicycle front-end mechanism of claim 3, wherein the stem set further comprises a cap coaxially connected with the positioning member along the center of the first combination bore through the connection member; the positioning member is disposed between the cap and the positioning plate.

6. The bicycle front-end mechanism of claim 5, wherein the first end of the connection tube part comprises a concavely disposed groove, and one side of the positioning member comprises a protrusion part, so that the groove and the protrusion part are engaged in a concave-convex manner.

7. The bicycle front-end mechanism of claim 6, wherein an outer periphery of the positioning plate comprises a concavely disposed positioning limiting groove; when the positioning member is connected with the positioning plate, the protrusion part of the positioning member is located in the positioning limiting groove.

8. The bicycle front-end mechanism of claim 6, wherein the positioning member comprises a connection part; the connection part comprises a first face and an opposite second face; the connection part has an opening passing therethrough, and the cap is connected with the first face and partially engaged in the opening; the second face integrally forms the protrusion part; the connection member is connected with the positioning plate through the opening.

9. The bicycle front-end mechanism of claim 8, wherein the cap comprises an outer lateral face and an opposite inner lateral face; the inner lateral face faces the first combination bore; the outer lateral face comprises a concavely disposed recess, and one end of the connection member is located in the recess; the inner lateral face comprises a protruding combination part, which has a trapezoid-shaped sectional face; the combination part is engaged in the opening.

10. The bicycle front-end mechanism of claim 1, wherein the fork bowl set further comprises a washer mounted around an outer periphery of the connection tube part and disposed between the upper bowl and the first combination bore of the stem.
